(19) United States
(12) Patent Application Publication
(10) Pub. No.: US 2012/0001452 A1
(43) Pub. Date: Jan. 5, 2012

(54) Cage Frame

(76) Inventors: Paul Melville, Glenalta (AU); Scott Hope, Mount Barker (AU)

(21) Appl. No.: 13/226,936

(22) Filed: Sep. 7, 2011

Related U.S. Application Data
(63) Continuation of application No. 12/377,619, filed on Feb. 16, 2009.

(30) Foreign Application Priority Data
Aug. 15, 2006 (AU) 2006904426

(51) Int. Cl. B62D 33/023

(52) U.S. Cl. 296/181.7

(57) ABSTRACT

The present invention relates to a post assembly (10) for use in constructing a cage or enclosure (20). The posts assembly (10) of the present invention provide a structural member for forming a cage (20) which can be used in a variety of situations. The posts (10) can be installed onto any trailer irrespective of their size or alternatively the enclosure can be free standing. The posts (10) can also accommodate walls of various heights and thicknesses. In a preferred embodiment the post assembly (10) includes a first and second longitudinally extending body portions (66) and (68) having respective passageways (76), an arm (40) adapted to engage coaxially aligned passageways (76) of respective first and second longitudinally extending body portions, wherein the post assembly (10) is adapted to releasably engage adjacent wall portions (22) such that the walls portions (22) are held in a substantially upright position.

### CROSS-REFERENCE TO RELATED APPLICATIONS

This application is a Continuation of U.S. application Ser. No. 12/377,619, filed Feb. 16, 2009, now pending, which entered the National Phase of Serial No. PCT/AU07/01154, filed Aug. 15, 2007, which claims priority to an Australian

Patent Application 2006904426, filed Aug. 15, 2006. The entire disclosure of these prior applications are hereby incorporated by reference.

### FIELD OF THE INVENTION

The present invention relates to a post assembly for use in forming a cage or enclosure. The invention has been developed primarily for use within a trailer and will be described hereinafter with reference to this application. However, it will be appreciated that the invention is not limited to this particular field of use and the post could be used to form a cage within the rear of a utility type vehicle or used to construct a free standing enclosure.

### BACKGROUND OF THE INVENTION

Semi permanent and permanent cage structures are used for various applications. Cages can be used to house animals such as livestock or within trailers to assist in haulage.

A conventional trailer is a useful haulage means that can be detachably coupled to a powered vehicle. Its ability to be detached from the vehicle enables trailers to be used infrequently with family vehicles or regularly by tradesman and the like. The most popular type of trailer towed behind passenger vehicles is the open box type design. Variations on this design are the fully enclosed type trailers and open top cage type, both of which are essentially constructed onto an open box type trailer. Typically, to construct these types of caged trailers a frame is welded onto the tray of the open trailer. Sides, and possibly a roof, can then be attached thereto. All these particular types of trailers have their own unique advantages.

The cage type trailers are popular as they are excellent for transporting bulky items, garden waste or boxes. The cage type trailers are also popular because they are useful for transporting tall items which need to remain upright, such as whitegoods, whilst the fully enclosed trailer provides a weatherproof transportation means. The difficulty with the fully enclosed type trailers is that they can increase wind resistance because of their height. The resultant drag decreases the fuel efficiency of the vehicle towing the trailer. Both the cage and enclosure types of trailers have restricted access, typically through a rear door or opening.

The cage and fully enclosed type trailers also have less application then the open type design and therefore people typically hire these types of trailers on the rare occasions that they are required. Some people convert their open trailers to cage or enclosure types, however the problem with converting the trailer is that once done it can be very difficult to convert it back again. Trailers are also of various dimensions and therefore it is not viable to produce a ‘one size fits all’ cage that can be easily installed onto an open box type trailer.

Conventional trailer cages are typically not able to be removed from the back of a trailer or utility and are usually custom-built. Likewise other cage structures are not able to be easily dismantled when not in use.

Any discussion of the prior art throughout the specification should in no way be considered as an admission that such prior art is widely known or forms part of the common general knowledge in this field.

It is an object of the present invention to overcome at least some of the aforementioned problems or provide the public with a useful alternative.

It is a further object of the present invention to provide for a post assembly for use in constructing a dismantleable enclosure.

### SUMMARY OF THE INVENTION

Therefore in one form of the invention there is proposed a post assembly for use in the construction of an enclosure, said post assembly including:
an upright body portion including a means of supporting a side edge of two upright wall portions such that the wall portions extend at an angle outwards from said upright body portion;
a moveable arm associated with said upright body portion, said arm including at least one cap means at an upper end thereof adapted to engage a top edge of the upright wall portions, said arm being vertically moveable to accommodate wall portions of different height above said body portion.

In preference the arm slidably engages the body portion.

Preferably the body portion includes a passageway adapted to accommodate the arm.

In preference the body portion includes a base plate. The base plate includes an attachment means adapted to facilitate the attachment of the post assembly to a surface on which the enclosure is mounted.

Preferably the body portion includes engagement means for facilitating the attachment of the wall portions thereto.

More preferably the body portion includes two channels extending along the height of the body portion at said angle and into which the walls portions are received.

Most preferably the channels include apertures to facilitate the securing of the wall portions within the channels.

In preference the cap means includes at least one inverted U-shaped flange adapted to receive the upper edge of the wall portions.

More preferably the at least one flange includes attachment means adapted to facilitate the securing of the wall portions thereto.

Additionally the at least one flange includes attachment means adapted to facilitate the securing of a roof thereto.

Preferably said means of supporting the wall portions is rotatable with respect to the body.

In preference said arm includes two cap means which are independently rotatable such that each cap means is rotatable to the same angle as each of the two rotatable wall portions.

Preferably the cap means includes attachment means adapted to facilitate the securing of the wall portions thereto.

Preferably the post assembly includes a locking means adapted to retain the arm in a fixed arrangement with respect to the body portion.

In a further form of the invention there is proposed a post assembly for use in the construction of a ficed-angle enclosure, said post assembly including:
an upright, hollow body portion including two wall panel receiving means extending at fixed angles outwards from said hollow body portion and adapted to support the side edge of each wall panel;
an arm adapted to slidably engage the holly body portion such that said arm is vertically moveable with respect to the body portion, said arm including inverted U-shaped cap portions at an upper end thereof which extend at substantially the same angle as each of the wall panel receiving means, said arm adapted to be moved vertically upwardly until said cap portions are disposed above the height of the wall panels and then lowered until the top edge of each wall panel is received inside each corresponding cap portion.

In a still further form of the invention there is proposed a post assembly for use in the construction of a variable-angle enclosure, said post assembly including:
an upright body portion including two wall panel receiving means being independently rotatable about said upright body portion and each being adapted to support the side edge of a wall panel;
an arm adapted to slidably engage the holly body portion such that said arm is vertically moveable with respect to the body portion, said arm including two cap portions at an upper end thereof which are also independently rotatable, said arm adapted to be moved vertically upwardly to a point where each cap portion is disposed above the height of each corresponding wall panel and is thus engageable with a top edge thereof.

In a yet further form of the invention there is proposed an enclosure constructed using a plurality of post assemblies and wall panels supported there between as defined above.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 is a perspective view of an enclosure mounted within a conventional trailer illustrating a first embodiment of the support post of the present invention;

FIG. 2 is an exploded view of the post of FIG. 1;

FIG. 3 is a perspective view of the cage of FIG. 1 with the rear wall removed;

FIG. 4 is a perspective view of a second embodiment of the support post of the present invention in a closed arrangement;

FIG. 5 is a perspective view of the post of FIG. 4 in an open arrangement;

FIG. 6 is an exploded view of the post of FIG. 4;

FIG. 7 is a perspective view of an enclosure constructed using the post of FIG. 4;

FIG. 8 is a perspective view of the enclosure of FIG. 7 in use;

FIG. 9 is a perspective view of an octagon shaped enclosure utilising the posts of FIG. 4; and

FIG. 10 is a perspective view of an enclosure with solid or opaque sides utilising the posts of FIG. 4;

FIG. 11 is a perspective view of an elongated trailer cage utilising the posts of FIG. 4.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

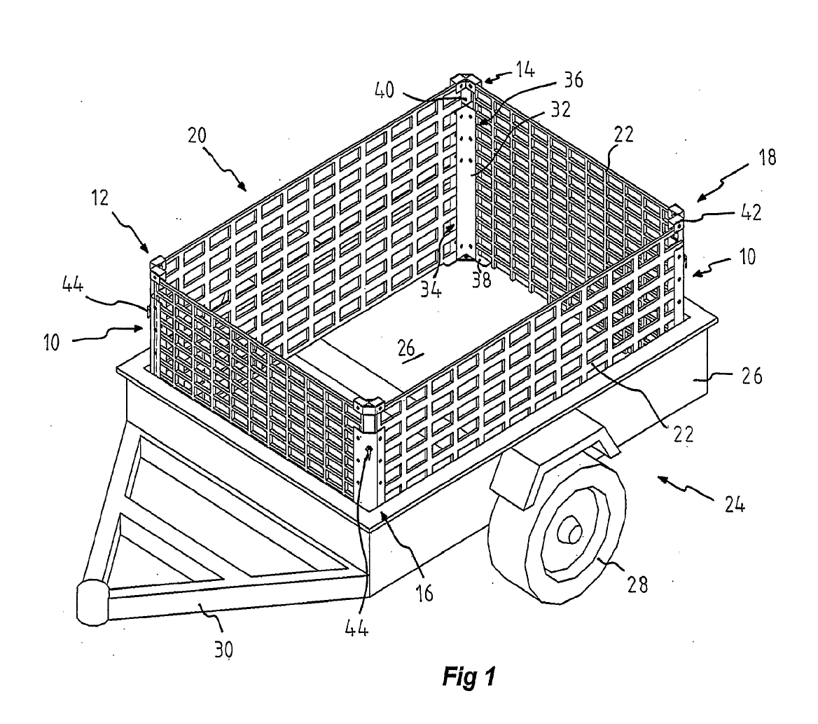

Referring to the drawings for a more detailed description, a support post assembly 10 is illustrated, demonstrating by way of examples, arrangements in which the principles of the present invention may be employed. FIG. 1 illustrates a first embodiment of the support post 10 which is positioned at corners 12, 14, 16 and 18 to form a frame for a cage or enclosure 20. The walls 22 of the cage 20 which extend therein between can be constructed from any rigid or semi-rigid sheet material.

The sheet material can be in the form of rectangular wooden lattice or any other suitable material. Such material is commonly available through hardware and gardening stores and different material can be used depending upon the application. For instance, the walls 22 can be constructed from, but not limited to, chip board, wooden lattice, rigid wire lattice, sheet metal, fibreglass or plastic.

The enclosure 20, as illustrated in FIG. 1, is positioned within a conventional open box trailer 24 which includes a tray 26, wheels 28 and a coupling frame 30 for connection to a powered vehicle. It should however be appreciated by the reader that the invention is not limited to use only within trailers. The invention could also be used in the tray of a utility type vehicle, in the rear of a 4WD or station wagon. It can also be used as a free standing enclosure for livestock or pets.

The post 10 includes a body 32 having two longitudinally extending channels 34 and 36, a base portion 38 adapted to fixably engage tray 26, an arm 40 which is adapted to slidably engage body 32, a top portion 42 attached to the free end of arm 40 and a locking member 44 adapted to secure the arm 40 in position. The posts 10 thereby secure the walls 22 in a fixed spatial arrangement during use. In this first embodiment the channels 34 and 36 are in a fixed arrangement such that the channels are located along substantially perpendicular planes.

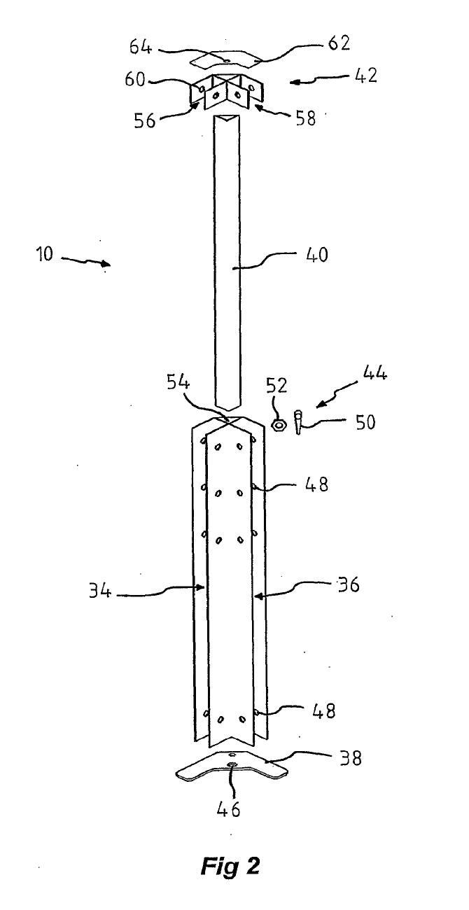

As further illustrated in FIG. 2 the base portion 38 includes apertures 46 which are engaged by bolts (not shown) to thereby secure the posts 10 to the tray 26 of the trailer 24. The longitudinally extending channels 34 and 36 are configured to accommodate walls or varying thickness and include a series of apertures 48 whereby the walls 22 are able to be secured within longitudinally extending channels 34 and 36 during use. It is envisaged that the locking member 44 is in the form of a wing nut arrangement comprises a lever 50 that is adapted to engage a nut 52. Rotation of lever 50 facilitates securing of the arm 40 by way of frictional engagement as is well known in the art. It should however be appreciated that other types of locking means could be used.

The arm 40 is adapted to engage passageway 54 and is held at a desired height by way of locking means 44. The top portion 42 which is attached to the free end of arm 40 comprises two outwardly pointing U-shaped portions 56 and 58, which are located along planes corresponding to longitudinally extending channels 34 and 36, and are adapted to engage the upper portion of adjacent walls 22. The U-shaped portions include a plurality of apertures 60 which can be used to secure the walls 22. The top portion 42 includes a cap 62 which prevents the arm 40 being retracted below the upper extremity of the sheet material that forms walls 22. The cap 62 further includes an aperture 64 which can be used to secure a lid or cover (not shown) on the enclosure 20.

It will now be appreciated that the post assembly can be securely fixed into position or temporally installed as desired.

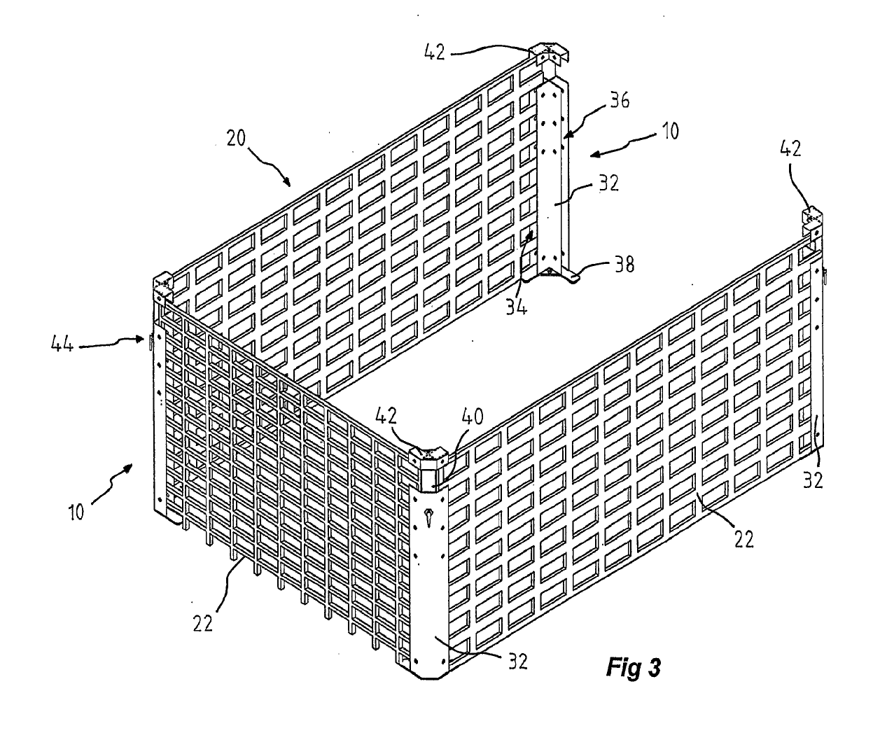

As illustrated in FIG. 3, the rear wall may be removed to allow easier access to the interior of the cage 20. Each channel 34 and 36 may include a leaf spring (not shown) adapted to secure walls 22 of various thicknesses. Likewise top portion 42 may also include a leaf spring.

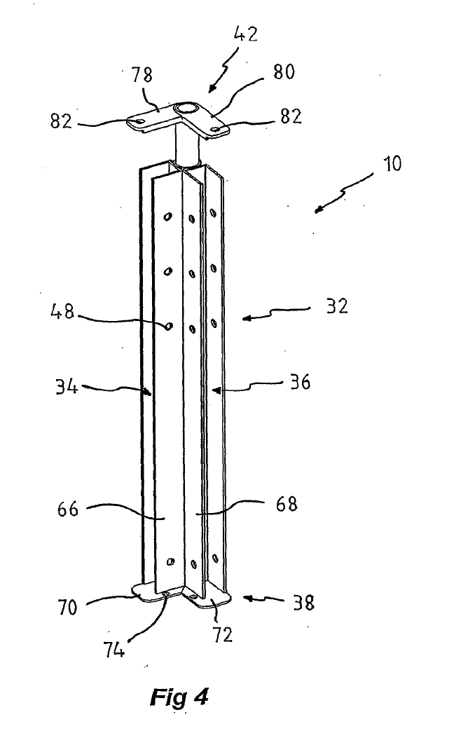

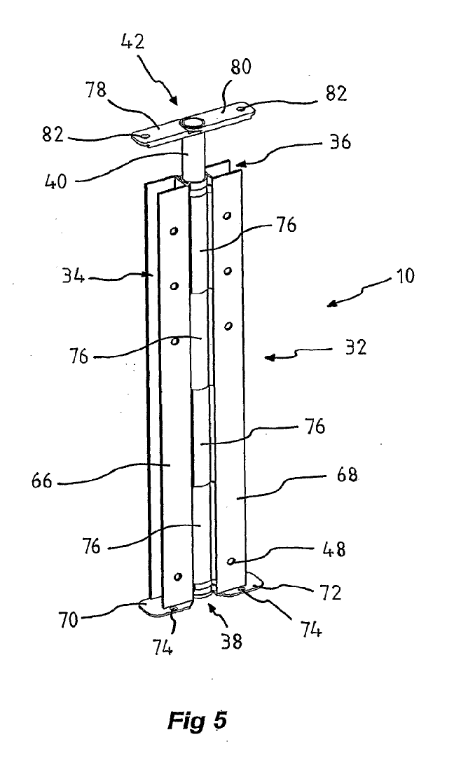

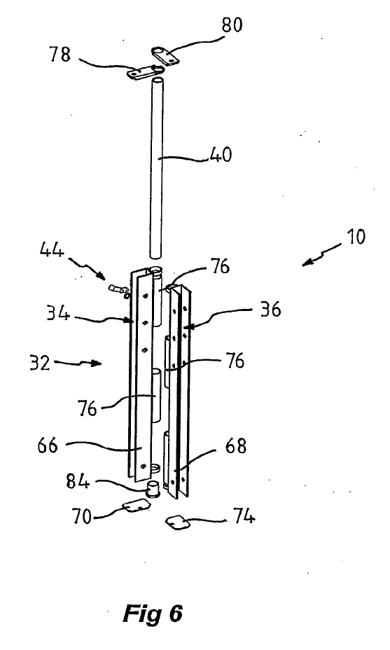

In a preferred embodiment, as illustrated in FIGS. 4 to 6, the body 32 comprises two cooperating individual segments 66 and 68 adapted to rotatably engage each other. Each member includes a respective base plate 70 and 72 which includes an aperture 74. The individual segments 66 and 68 include passageway portions 76 which when coaxially aligned form an interlocking single passageway adapted to slidably accommodate arm 40, as illustrated in FIG. 5.

The top portion 42 comprises two independent flange portions 78 and 80 which include apertures 82. The apertures 82 can be used to either fix the wall portions 22 or a roof (not shown) by way of screws or bolts.

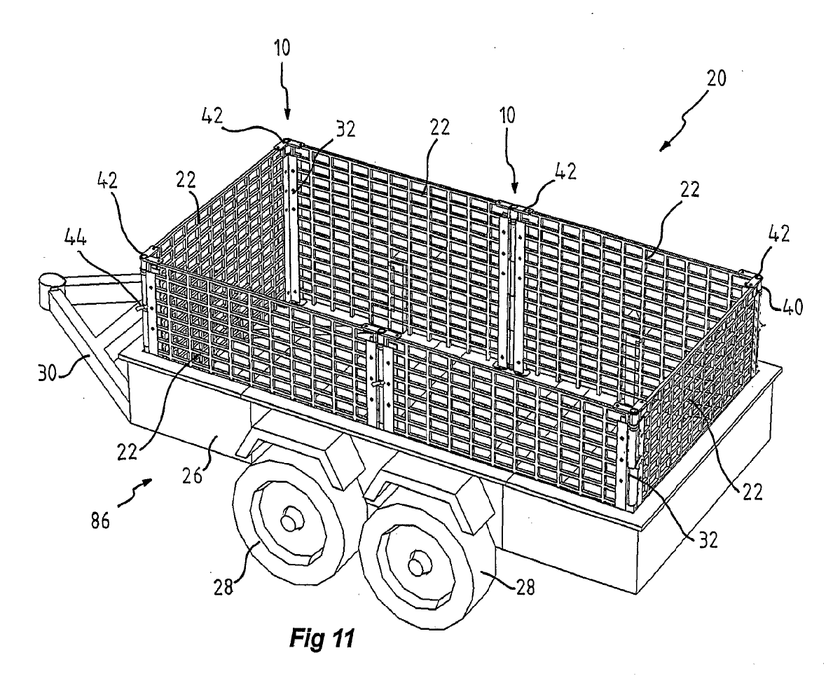

The arm 40 acts as an axle around which the individual segments 66 and 68 are able to move in a hinge type arrangement. The body 32 can be moved between a first position, as illustrated in FIG. 4, wherein the planes of the channels 34 and 36 are substantially perpendicular, to a second position, as illustrated in FIG. 5, wherein channels 34 and 36 are positioned along substantially the same plane. The reader would appreciate that this means the same hinged post 10 can be used at a corner of an enclosure or along the side of the enclosure to join adjacent wall portions 22 as illustrated in FIG. 11.

The post 10 further includes a locating member 84 to ensure that when assembled the passageway portions 76 do not disengage.

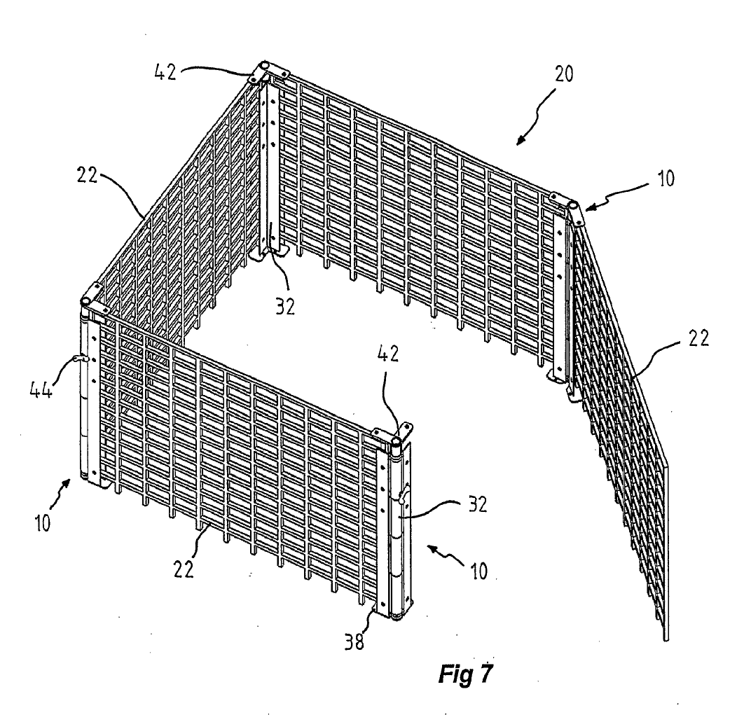

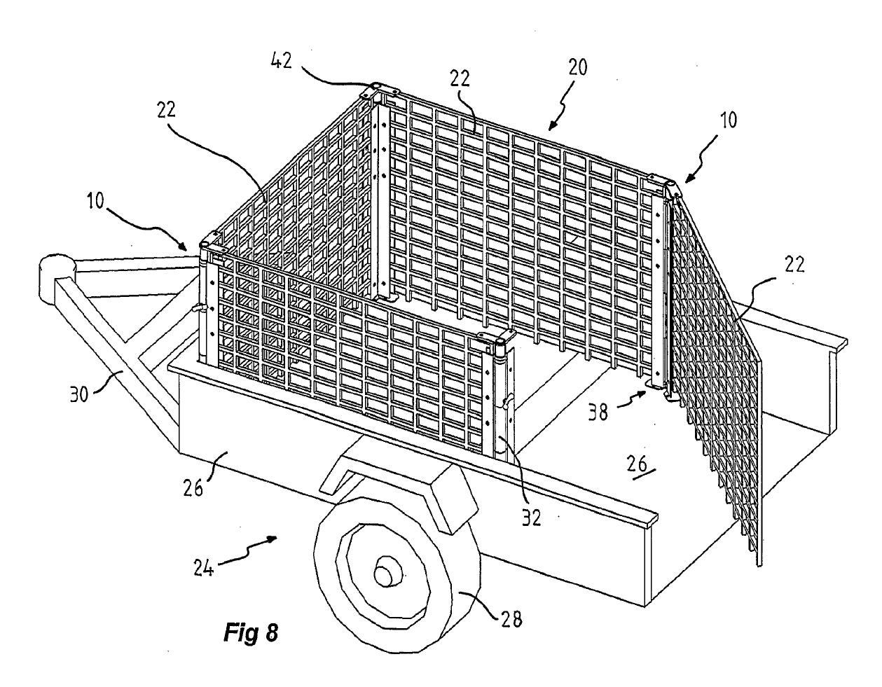

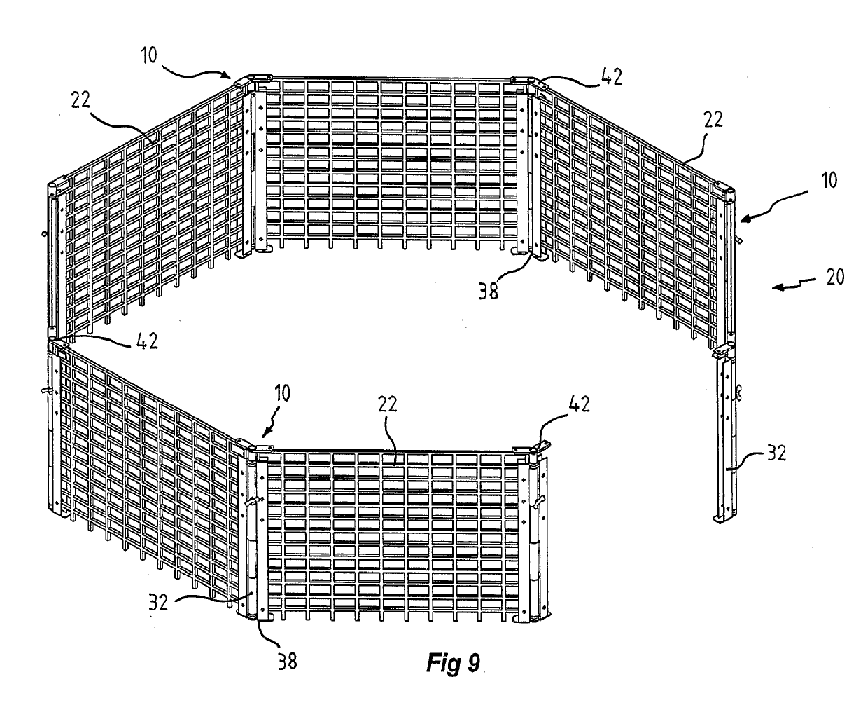

As illustrated in FIG. 7 the use of a hinge type post 10 means that one wall 22 of the enclosure can be moved to act as a door. This would be particularly useful when the enclosure 20 is being used in a trailer, as illustrated in FIG. 8 or when livestock is being accommodated. Similarly due to the hinged arrangement of the posts 10 different polygon shaped enclosures can be constructed. For instance, as illustrated in FIG. 9 an octagon shaped enclosure could be constructed.

Different types of material can be used to form the walls 22 of the enclosure.

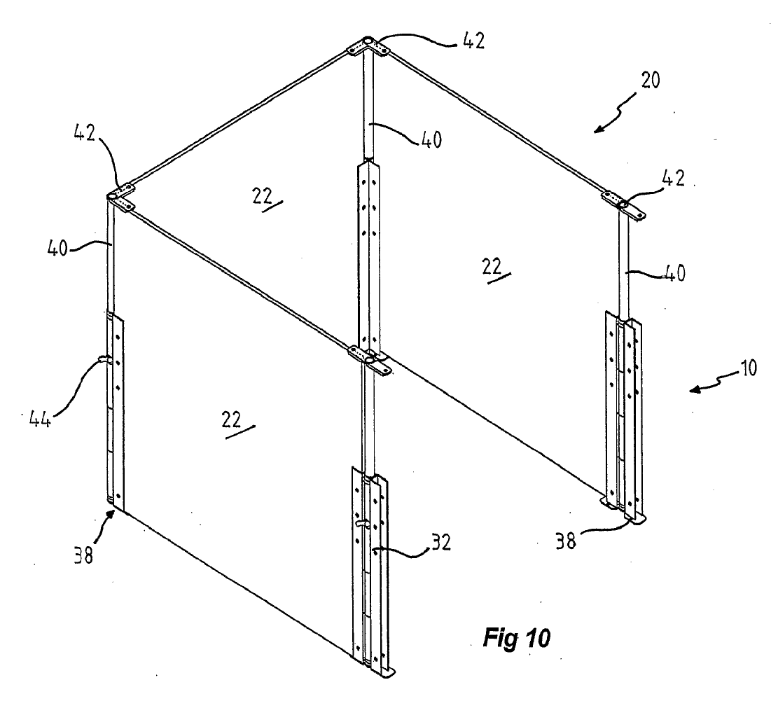

As illustrated in FIG. 10 opaque or semi transparent sheet material could be used. Semi transparent sheet material could be used to build temporary glass houses.

The post assembly 10 can also be attached to the sides of the trailer or the trailer may include a female member into which the post can be inserted. Alternatively the body 32 may be pivotable about the base 38 such that it is able to be folded down when not in use.

As the reader will now appreciate the hinged posts 10 can be used to form enclosure of different diameters and shapes. As illustrated in FIG. 11 the hinged posts 10 can be used to form an elongated rectangular enclosure within a dual axle trailer 86.

It will now be appreciated that the opposing channels 34 and 36 of the hinged post 10 can be positioned between 90-180° such that the posts could be used to form different polygon shaped cages, such as but not limited to, a hexagon, octagon or pentagon. The invention enables a user to construct a cage 20 of any desired size by simply cutting the sheet material to a suitable length and width and securing it between adjacent posts 10.

Although the posts can be fixed to the trailer by way of bolts it should be appreciated that the invention is not limited to this particular embodiment. For instance magnets or clips could be used to secure the posts within a trailer or tray top of a vehicle. Furthermore, although in the preferred embodiment an arm slidably engages the body it should be appreciated that the posts in their simplest form could be a telescopic body portion which is able to be attached to a surface, such as a trailer, wherein the body is adapted to securely engage the walls.

The skilled addressee will now appreciate the many advantages of the present invention. The posts 10 provide a structural member for forming a cage which can be used in a variety of situations. For instance the posts 10 can be installed onto trailers irrespective of their size. Furthermore, the posts 10 can accommodate walls of various heights.

Further advantages and improvements may very well be made to the present invention without deviating from its scope. Although the invention has been shown and described in what is conceived to be the most practical and preferred embodiment, it is recognized that departures may be made therefrom within the scope and spirit of the invention.

In any of the claims that follow and in the summary of the invention, except where the context requires otherwise due to express language or necessary implication, the word “comprising” is used in the sense of “including”, i.e. the features specified may be associated with further features in various embodiments of the invention.

1. A cage frame adapted to form a raised enclosure above a vehicle trailer bed, said cage frame including:
upright post assemblies adapted to be placed at each corner of the trailer bed;
upright wall portions extending between each upright post assembly; and
wherein each upright post assembly includes an upright hollow body with wall portion receiving brackets associated therewith, said receiving brackets adapted to receive and thereby support two wall portions which terminate at said post assembly, said post assembly further including an arm that is vertically slideable inside said hollow body said arm having a cap means at an upper end thereof adapted to engage a top edge of each upright wall portion notwithstanding the height of each wall portion above said trailer bed.

2. A cage frame according to claim 1 wherein each upright post assembly includes a base plate configured to sit above said trailer bed.

3. A cage frame according to claim 2 wherein the base plate is configured to sit above the trailer bed at said corner and support said post assembly without the use of any external fixings.

4. A cage frame according to claim 2 wherein the base plate includes attachment means to facilitate the attachment of the post assembly to the trailer bed.

5. A cage frame according to claim 1 wherein each wall portion receiving bracket includes a channel extending along the height of the hollow body and at an angle corresponding with the angle of the wall portion according to the shape of the trailer bed.

6. A cage frame according to claim 5 wherein each bracket includes apertures to facilitate the securing of the wall portions within the channels.

7. A cage frame according to claim 1 wherein the cap means includes at least one inverted U-shaped flange adapted to receive the upper edge of the wall portions.

8. A cage frame according to claim 7 wherein the at least one flange includes attachment means adapted to facilitate the securing of the upper edge of the wall portions thereto.

9. A cage frame according to claim 7 wherein the at least one flange includes attachment means adapted to facilitate the securing of a roof thereto.

10. A cage frame according to claim 1 wherein each post assembly includes a locking means adapted to retain the arm at a fixed height.

11. A trailer including a flat trailer bed and a cage frame forming a raised enclosure in said trailer bed, said cage frame being as defined in claim 1.

12. A cage frame according to claim 1 wherein means of supporting the wall portions are rotatable with respect to the body portion.

13. A cage frame according to claim 1 wherein said arm includes two cap means which are independently rotatable such that each cap means is rotatable to the same angle as each of the two rotatable wall portions.
